(19) United States
(12) Patent Application Publication
(10) Pub. No.: US 2009/0320819 A1
(43) Pub. Date: Dec. 31, 2009

(54) CARBON NANOTUBE FIBER WIRE FOR WAFER SLICING

(76) Inventors: Robert Z. Bachrach, Burlingame, CA (US); Kaushal K. Singh, Santa Clara, CA (US); Omkaram Nalamasu, San Jose, CA (US); John Christopher Moran, Menlo Park, CA (US)

Correspondence Address: APPLIED MATERIALS;C/O PILLSBURY WINTHROP SHAW PITTMAN LLP, P .O . BOX 10500, MCLEAN, VA, 22120, US

(21) Appl. No.: 12/124,372

(22) Filed: May 21, 2008

(51) Int. Cl. B28D 1/06; B26D 1/547

(52) U.S. Cl. 125/16.02; 125/20; 83/651.1; 977/902

(57) ABSTRACT

A wire saw for cutting hard materials includes a carbon nanotube fiber wire spun from carbon nanotubes. The carbon nanotube fiber wire may be made from a plurality of fibers, each fiber being spun from carbon nanotubes, the fibers being twisted together to form the wire. Furthermore, the wire may also include diamond particles, silicon carbide particles and/or extra carbon nanotubes to enhance the abrasive properties of the wire. A method is provided for slicing a silicon boule including: linearly translating a carbon nanotube fiber wire between rotating drums while maintaining the wire under tension; using a fixture, moving the silicon boule onto the moving tensioned wire, whereby the wire cuts into the silicon; delivering lubricating fluid to the surface of the silicon where contact is made with the wire; and collecting the lubricating fluid after it leaves the surface of the silicon.

### FIELD OF THE INVENTION

The present invention relates generally to wire saws for cutting hard materials, and more particularly to a wire saw with a carbon nanotube fiber wire for cutting silicon boules.

### BACKGROUND OF THE INVENTION

Wire saws are used to cut hard and brittle materials. They are used to cut silicon wafers from silicon boules/ingots for the semiconductor and photovoltaic industries. Schematic diagrams of wire saws used for cutting silicon wafers are shown in FIGS. 1, 2 & 3. FIG. 1 shows a prior art wire saw with a single wire 105 fed between two reels 110. The wire 105 passes over four drums 115 multiple times, forming a web of wires 120 for cutting a hard material 125 held by a fixture 130. For the sake of simple illustration, a web 120 of only three cutting wires is shown. However, in practice a web for cutting a silicon boule will contain a large number of wires. The number of wires being determined by the number of wafers to be cut simultaneously from the boule. The drums 115 are used both to move the wire 105 linearly, as indicated, and to help maintain a proper tension in the wire 105. (The wire may be tensioned by two tensioning devices positioned between the first reel and the drums and the second reel and the drums. Such tensioning devices are not shown in the figure.) The drums 115 rotate about their central axes. The hard material 125 is fixed to a fixture 130. The fixture 130 is configured to move in a direction perpendicular to the web of wires 120, such that the hard material 125 can be moved onto the web of wires 120 and cut by the moving wires. An example of such a wire saw and further details are provided in U.S. Pat. No. 5,829,424.

FIG. 2 shows a prior art wire saw with a multiplicity of closed loop wires 205. Three wires 205 form a web of wires 220 for cutting a hard material 125 held by a fixture 130. For the sake of simple illustration, a web 220 of only three cutting wires is shown. However, in practice a web for cutting a silicon boule will contain a large number of wires. The number of wires being determined by the number of wafers to be cut simultaneously from the boule. The drums 215 are used both to move the wires 205 linearly, as indicated, and to tension the wires 205. The drums 215 rotate about their central axes. In order to tension the wires 205, the separation of the drums 215 can be adjusted. The hard material 125 is fixed to a fixture 130. The fixture 130 is configured to move in a direction perpendicular to the web of wires 220, such that the hard material 125 can be moved onto the web of wires 220 and cut by the moving wires. An example of such a wire saw and further details are provided in U.S. Pat. No. 6,550,364.

FIG. 3 shows a prior art variation on the wire saw of FIG. 2. In FIG. 3 the hard material 125 is fixed to a fixture 355 which allows for reciprocating motion of the hard material 125 relative to the wire 205. The fixture 355 also allows for the hard material 125 to be moved vertically, as shown, perpendicular to the wires 205. This combination of vertical and oscillating motions allows for cutting of the hard material 125 on stationary wires 205. Although, in practice the wires 205 may also be moved as indicated either intermittently or continuously. The fixture is comprised of a first part 330 which is able to move laterally relative to a second part 335. The second part 335 is able to rotate about an axis defined by the shaft 336, as shown. The second part 335 is coupled to a third part 340 by the shaft 336. The third part 340 is able to move vertically relative to a fixed fourth part 345, as shown. The vertical and lateral movements are facilitated by bearings 350. An example of such a wire saw and further details are provided in U.S. Pat. No. 6,886,550.

FIG. 4 shows a schematic of a cross section through a silicon boule 425 during the process of being cut by a wire saw, such as shown in FIGS. 1, 2 and 3. The plane of the section is perpendicular to the length of the wires 405. Thus in a wire saw with wires that move relative to the silicon boule 425, the wires 405 in FIG. 4 will move linearly in a direction perpendicular to the plane of the section and the silicon boule 425 will be move down onto the cutting wires 405, as shown. The wires 405 cut into the silicon 425, forming slots 426. As cutting continues, the slots 426 are cut deeper into the silicon boule 425. Such a slot is referred to as a kerf. The kerf is typically wider than the diameter of the cutting wire 405. On completion of cutting, the silicon remaining between the slots 426 will be silicon wafers. The cutting process relies on either: (1) a cutting fluid containing abrasive particles in the slots 426; or (2) wires 426 covered with abrasive particles, such as silicon carbide. Furthermore, a lubricating fluid is required to conduct away heat generated during cutting and to remove silicon debris from the slots 426.

The photovoltaic industry has a high demand for thin wafers, currently less than 200 microns thick and expected soon to reach 100 microns thickness. In order to efficiently produce silicon wafers with ever diminishing thickness the following issues must be addressed: (1) there is a need to reduce the loss of silicon from the kerf when cutting wafers; (2) there is a need to reduce the viscosity of the cutting fluid in order to maintain throughput for wafer cutting as the wafer thickness is reduced; and (3) there is a need to be able to efficiently recapture silicon lost from the kerf, to be recycled into silicon boules.

The loss of silicon from the kerf can be reduced by using cutting wires with smaller diameters. Currently, cutting wires are no smaller than 120-150 microns in diameter, primarily limited by the strength of available steel wire. Clearly, without a reduction in wire diameter, this will soon lead to a kerf which is wider than the wafer being cut, as the industry requires thinner and thinner wafers. The problem with thinner wires made of steel and similar materials is that they do not have the mechanical strength required for the current sawing process. Consequently, there is a need for thinner sawing wires with better mechanical properties.

The viscosity of the lubricating/cutting fluid must be reduced in order to maintain the current throughput and efficiency for cutting a boule, as the wafer thickness is reduced. As the width of the kerf is reduced this also requires the viscosity of the lubricating/cutting fluid to be reduced to allow for the same throughput and efficiency. The introduction of abrasive wires—metal wires coated with diamond particles—has allowed for reduced viscosity of the cutting fluid, since there is no longer a need for abrasive particulates in the cutting fluid. (Although, currently the processes used to coat wires with diamond do not produce sufficiently uniform wires of the lengths required for cutting silicon wafers for photovoltaic applications.) In this case the fluid becomes primarily a lubricating fluid. However, current lubricating fluids based on glycol and similar chemicals will be too viscous as kerf widths are reduced to approach 100 microns. The viscosity of current lubricating fluids will require a reduction in the speed of the wire as these small kerf widths are approached. Furthermore, in order to increase throughput, higher wire speeds are required, which will require lower viscosity lubricating fluids. Consequently, there is a need for lower viscosity lubricating fluids.

In order to capture the silicon lost from the kerf, and to be able to recycle the silicon into semiconductor grade silicon boules, the following must be addressed. First, there must be an efficient means for collecting the silicon lost from the kerf. Most of the silicon ends up in the lubricating fluid in the form of particulates which must be filtered out. This can only easily be achieved when using lubricating fluids which do not contain abrasive particles such as silicon carbide. Second, the lubricating fluids must be free from metal contaminants which can render the silicon unusable for making semiconductor grade silicon boules. The use of metal cutting wires results in metal contaminants getting into the lubricating fluid and onto the silicon particulates lost from the kerf. Consequently, there is a need for cutting/lubricating fluids from which silicon particulates can efficiently be separated and there is a need for cutting wires that do not contaminate the silicon lost from the kerf.

Therefore, there remains a need for tools and methods that can meet the wafer cutting requirements of the semiconductor and photovoltaic industries while allowing for cost reduction and increased efficiency.

### SUMMARY OF THE INVENTION

The concepts and methods of the invention allow the cost and complexity of cutting hard materials to be reduced by providing a wire saw with a wire having better mechanical properties than for metal wires. Furthermore, the invention provides a cutting tool and method which do not produce metal contamination in the cutting lubricant/slurry. This reduces the cost and complexity of recycling silicon kerf loss from the cutting lubricant after slicing silicon ingots. This can reduce the cost for broad market applicability as well as providing yield improvements. According to aspects of the invention, these and other advantages are achieved with the use of carbon nanofiber and carbon nanotube fiber wires, instead of the metal wires used in the prior art. As such, this invention contemplates a wire saw for cutting hard materials, the wire saw including a carbon nanotube fiber wire spun from carbon nanotube filaments. The carbon nanotube fiber wire may be made from a plurality of fibers, each fiber being spun from carbon nanotubes, the fibers being twisted together to form the wire. Furthermore, the wire may also have diamond particles, silicon carbide particles and/or extra carbon nanotubes incorporated into the wire to enhance the abrasive properties of the wire. The diamond particles, silicon carbide particles and/or carbon nanotubes may be incorporated during the process of twisting together the fibers to form a wire.

According to further aspects of the invention, a method is provided for slicing a silicon boule including the following steps: linearly translating a carbon nanotube fiber wire between two rotating drums while maintaining the wire under tension; using a fixture, moving the silicon boule onto the moving tensioned wire, whereby the wire cuts into the silicon; delivering lubricating fluid to the surface of the silicon where contact is made with the wire; and collecting the lubricating fluid after it leaves the surface of the silicon. The collected lubricating fluid is then available for recycling, which may include recovering silicon from the fluid. Furthermore, the recycling may include recovering carbon nanotubes from the lubricating fluid.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic of a prior art wafer wire saw with a single wire fed between two spools;

FIG. 2 is a schematic of a prior art wafer wire saw with closed wire loops;

FIG. 3 is a schematic of a prior art wafer wire saw with reciprocating motion between the hard material and the wire;

FIG. 4 is a schematic representation of a cross-section through a silicon boule being cut on a wafer wire saw;

FIG. 5 illustrates a plied carbon nanotube fiber wire of the invention;

FIG. 6 illustrates a schematic cross-section of a carbon nanotube fiber wire with incorporated diamond grit, according to the invention;

FIG. 7 illustrates a schematic cross-section of a carbon nanotube fiber wire with incorporated carbon nanotubes, according to the invention;

FIG. 8 is a schematic of a wafer wire saw of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

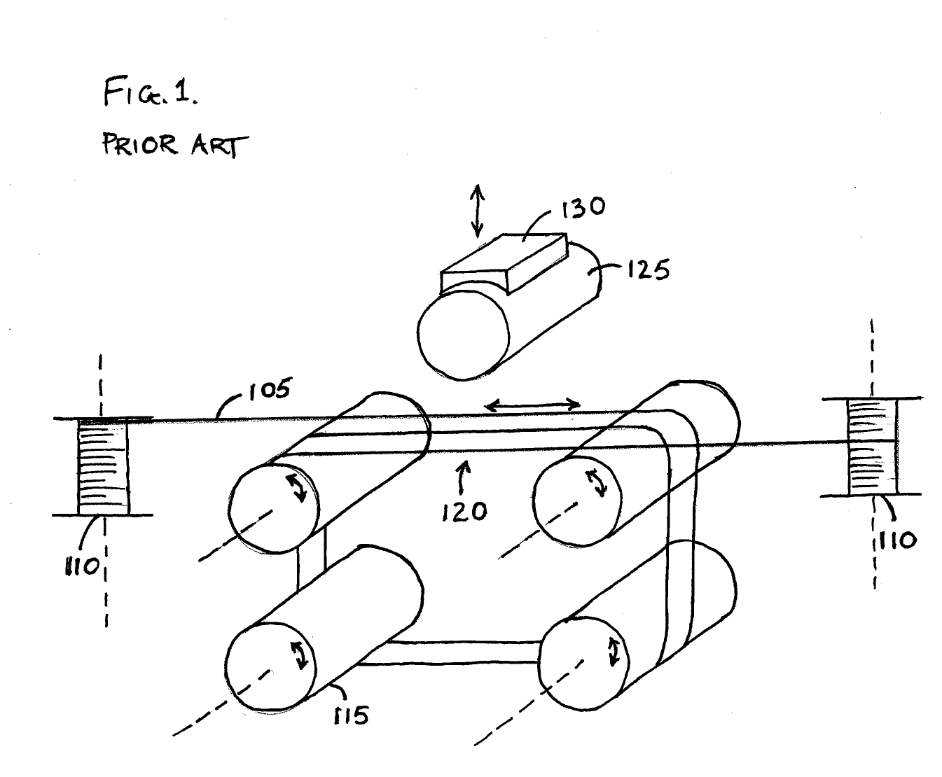

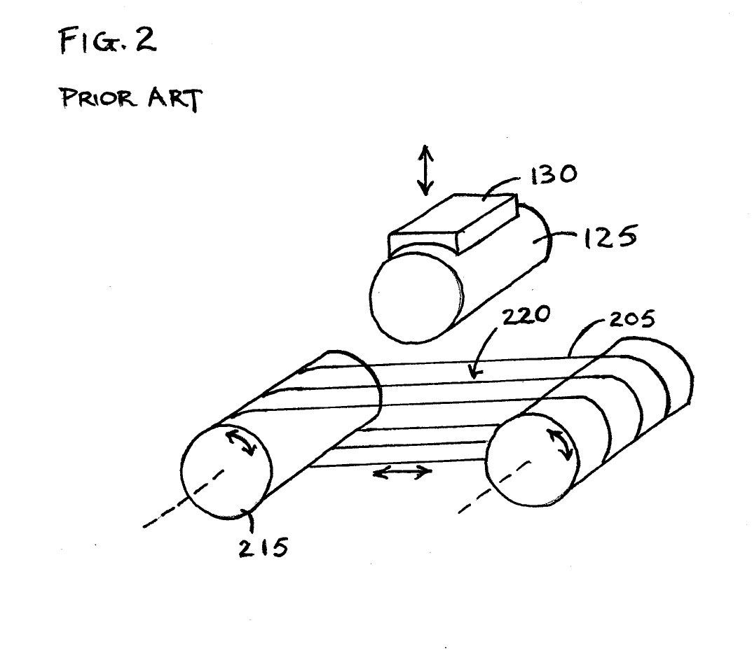

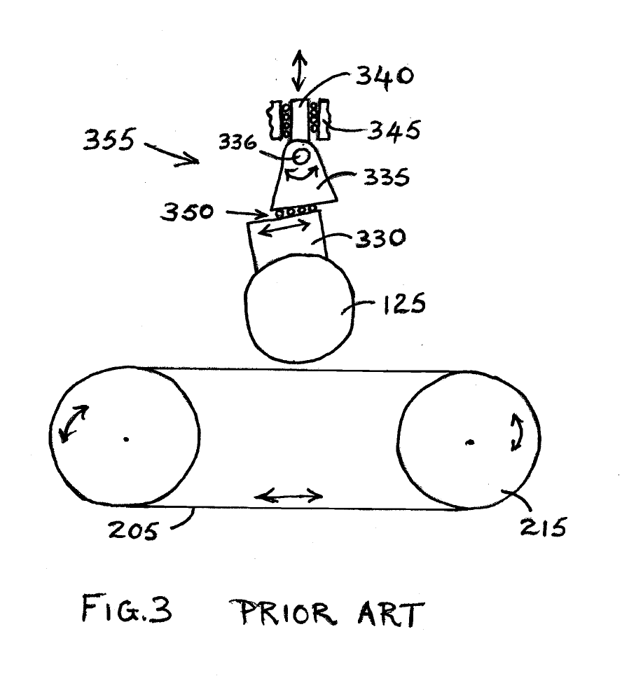

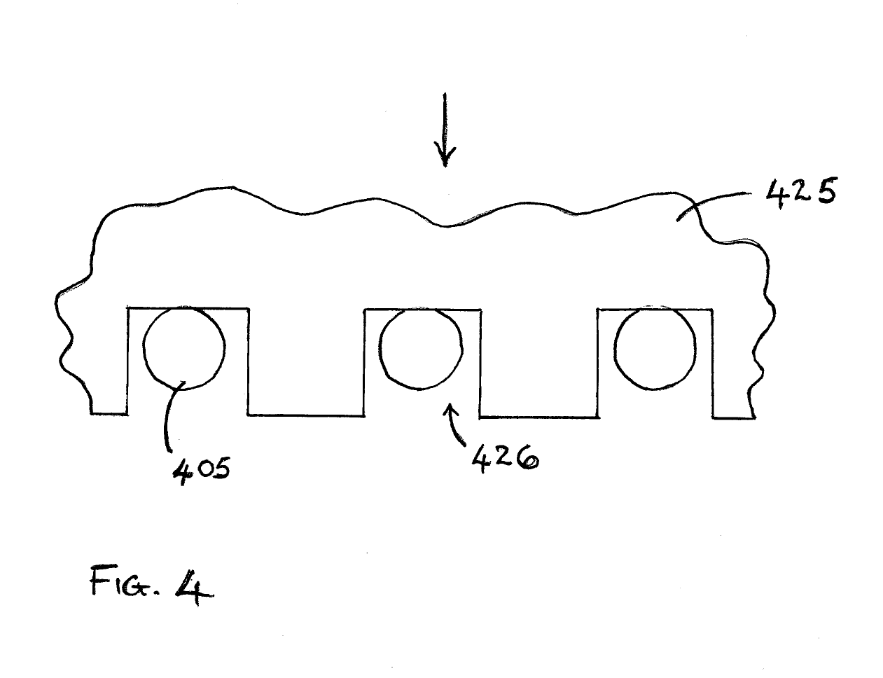

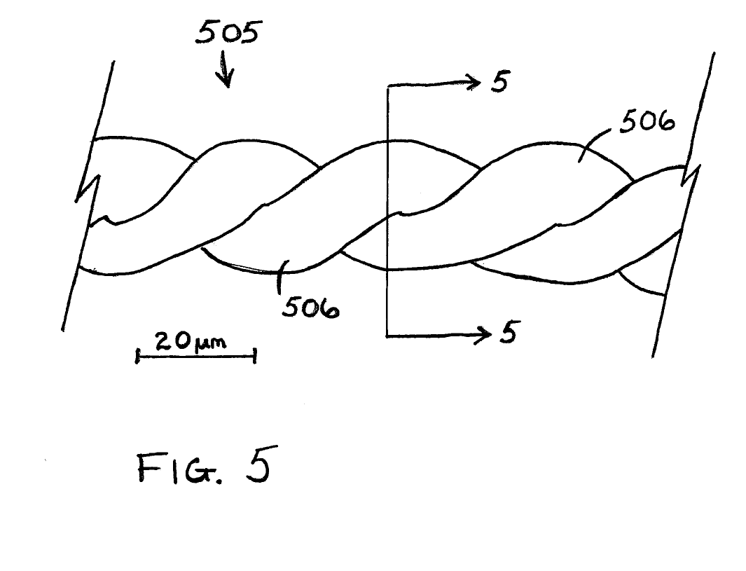

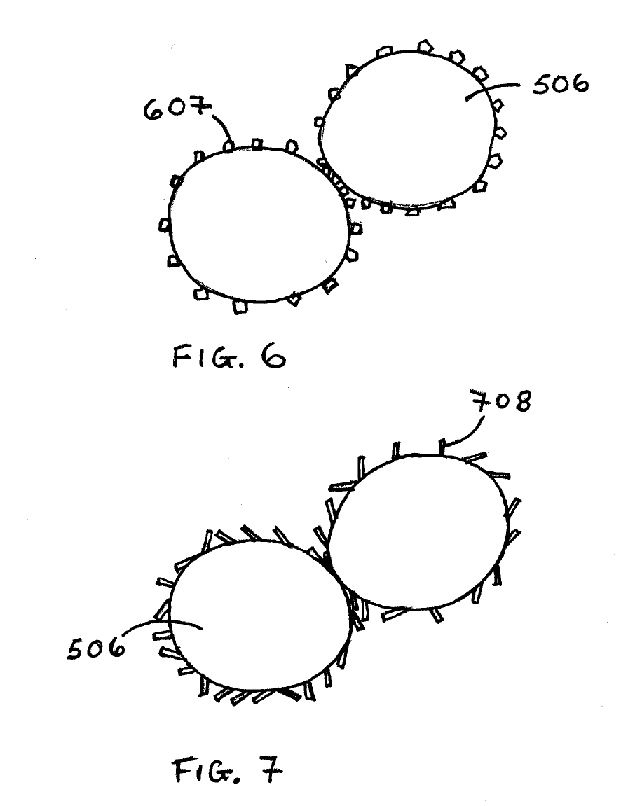

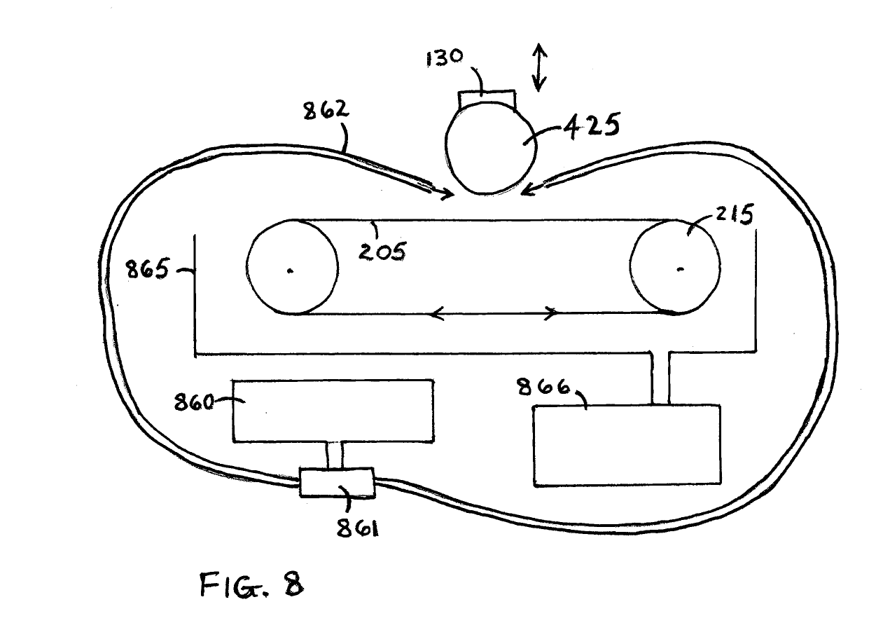

In general, the present invention contemplates incorporation of carbon nanotube fiber wires in wire saws used for cutting hard materials, in particular silicon wafers. Wire saws are used widely in industries such as the semiconductor and photo-voltaic industries. For example, see U.S. Pat. Nos. 5,829,424, 6,550,364, and 6,886,550, all of which are incorporated by reference herein. Wire saws include reel-to-reel wire saws, such as shown in FIG. 1, requiring very long wires, and closed-loop wire saws, such as shown in FIGS. 2 and 3, which need only relatively short wires. The present invention contemplates incorporating carbon nanotube fiber wires into both reel-to-reel and closed-loop wire saws.

Carbon nanotubes are nanometer-scale cylinders with walls formed of graphene—single atom thick sheets of graphite. Nanotubes may be either single-walled (cylinder wall composed of a single sheet of graphene, referred to as SWNTs) or multi-walled (cylinder wall composed of multiple sheets of graphene, referred to as MWNTs). Single-walled nanotubes have a diameter of the order of one nanometer. Nanotubes exhibit extraordinary mechanical properties, most notably exceptional strength. Carbon nanotubes can be spun into fibers and these fibers can then be plied (twisted) together to form multi-ply yarns. These fibers and yarns can be in excess of one meter in length and exhibit tensile strength in the range of 150-460 MPa. See Zhang et al., Science 306, 1358-(2004) and Li et al., Science 304, 276 (2004). The present invention contemplates using SWNTs and/or MWNTs to form the fibers in the carbon nanotube fiber wires.

FIG. 5 shows an illustration of a magnified view of a carbon nanotube fiber wire 505, according to the invention. Such a carbon nanotube fiber wire 505 replaces the metal wires currently used in wire saws. In FIG. 5, a two-ply wire is shown—the wire 505 is comprised of two spun fibers 506, 10 microns in diameter, twisted together to form a 20 micron diameter wire. Spinning the carbon nanotubes together to form the fibers 506, and then twisting together the fibers to form the wire 505 adds strength to the wire 505. Note that a 10 micron diameter fiber will contain of the order of 10⁶ nanotubes spun together. The wire is not restricted to fibers of a particular diameter, and is not limited to a specific number of plied fibers. For example, four 8 micron diameter fibers could be plied together to form an approximately 24 micron diameter wire. Furthermore, a large number of smaller diameter fibers can be plied together to form a wire. By analogy to the ancient processes of spinning and plying thread and yarn, there is no limit to the length of wire that can be formed. Various methods for forming carbon nanotube fibers and plying such fibers are known to those skilled in the art of carbon nanotubes.

The surface of the carbon nanofiber or carbon nanotube fibers is decorated with the ends of individual component carbon nanotubes. This makes the surface of nanotube fibers somewhat abrasive, and thus provides an abrasive cutting wire. The abrasive properties can be enhanced with diamond-phase carbon on the surface of the fibers. The diamond-phase carbon can be deposited on the fiber surface or grown on the fiber surface using chemical vapor deposition (CVD) or related techniques. The abrasive properties of carbon nanotube fiber wires can also be enhanced by incorporating abrasive particles such as silicon carbide or diamond particles into the wires. Incorporation of these abrasive particles can be accomplished by a variety of techniques. For example: abrasive particles can be introduced while plying together the fibers in a solution with a suspension of the particles; individual fibers can be coated with abrasive particles and then the fibers can be plied together; the wire can be coated with abrasive particles using vapor phase deposition, or electrochemical deposition methods; etc. FIG. 6 shows a representation of a carbon nanotube fiber wire incorporating abrasive particles. FIG. 6 shows a cross-section along 5-5 of the two-ply wire 505 shown in FIG. 5, with the addition of abrasive particles 607. The particles 607 are shown on the surface of the fibers 506. The density of abrasive particles and their size will be varied to suit the type of cutting required. Particle dimensions will typically be a small percentage of the final cutting wire diameter. For example, if the wire diameter is 50-70 microns, the abrasive protuberances should be approximately 2-5 microns.

The abrasive properties of the wire may also be enhanced by incorporating extra carbon nanotubes into the wire—the objective being to substantially increase the density of nanotube ends on the surface of the wire. Incorporation of these extra nanotubes may be accomplished using techniques such as those described above for abrasive particles and as part of the carbon fiber fabrication process. FIG. 7 shows a representation of a carbon nanotube fiber wire incorporating extra carbon nanotubes. FIG. 7 shows a cross-section along 5-5 of the two-ply wire 505 shown in FIG. 5, with the addition of carbon nanotubes 708. The nanotubes 708 are shown on the surface of the fibers 506. The density of nanotubes, their size and their type (SWNTs or MWNTs) will be varied to suit the type of cutting required. Typically, nanotubes will be incorporated into carbon nanotube fiber wires at the level of 5-10% by weight.

As with metal wires, a lubricating fluid is required for use of the carbon nanotube fiber wire of the invention in a wire saw. The lubricating fluid may contain an abrasive such as silicon carbide particles. However, it is preferred to use the carbon nanotube fiber wires without an abrasive in the lubricating fluid.

Carbon nanotube fiber wires can be made with smaller diameters than metal wires due to their superior mechanical properties. This allows for cutting thinner wafers, conceivably down to 50 microns thick. However, in order to reduce the thickness of wafers being cut without reducing the speed of cutting, lower viscosity lubricating fluids are required. This will require a move away from glycol-based and oil-based lubricants to lower viscosity lubricants, such as water-based lubricants. Ultimately the wire should work with any suitable lubricant or cutting fluid. Additionally, the carbon nanotube fiber wires may be coated with a passivation layer as described in U.S. Pat. No. 6,902,947.

When cutting silicon wafers with a wire saw a majority of the silicon lost from the kerf ends up in the lubricating fluid. Metal cutting wires contaminate the silicon in the lubricating fluid, making recycling very difficult and expensive. However, utilizing carbon nanotube fiber wires in wire saws eliminates the major source of metal contamination and allows cost effective recycling of silicon from the lubricating fluid. FIG. 8 shows a wire saw of the invention, configured for recycling silicon from the lubricating fluid. In FIG. 8, lubricating fluid is delivered to the hard material, in this case a silicon boule 425, where it meets the cutting wires 205. The lubricating fluid is pumped from a container 860 by a pump 861 through conduits 862 to the silicon surface being cut. As the lubricating fluid leaves the silicon surface it is captured by a tray 865 and drained into a reservoir 866 for storing. In some embodiments the reservoir 866 and the container 860 are connected, and in other embodiments the reservoir 866 and the container 860 are one and the same.

The lubricating fluid containing silicon lost from the kerf is available from the reservoir 866 for recycling. When abrasive particles are not used in the lubricant, the used lubricant is filtered to remove the silicon particulates lost from the kerf. These particulates can then be used in the manufacture of more silicon boules.

The lubricating fluid in the reservoir 866 may also contain carbon nanotubes lost from the wire. These carbon nanotubes can be reclaimed from the lubricating fluid.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A wire saw for cutting a hard material comprising a carbon nanotube fiber wire spun from carbon nanotubes.

2. The wire saw of claim 1, wherein said wire comprises a plurality of fibers spun from carbon nanotubes, said fibers being twisted together to form said wire.

3. The wire saw of claim 2, wherein said wire further comprises diamond particles incorporated on the surface of said fibers, for making said wire more abrasive.

4. The wire saw of claim 2, wherein said wire further comprises silicon carbide particles incorporated on the surface of said fibers, for making said wire more abrasive.

5. The wire saw of claim 2, wherein said wire further comprises carbon nanotubes incorporated on the surface of said fibers, for making said wire more abrasive.

6. The wire saw of claim 1, further comprising:
a first system configured to deliver lubricating fluid to the surface of said hard material where contact is made with said wire; and
a second system configured to capture said lubricating fluid after said lubricating fluid leaves the surface of said material.

7. The wire saw of claim 6, wherein said lubricating fluid is water-based.

8. The wire saw of claim 6, wherein said hard material is silicon.

9. A wire saw for cutting a hard material, comprising:
a carbon nanotube fiber wire spun from carbon nanotubes;
a mechanism configured to linearly translate said wire along a path and to maintain said wire under tension along said path; and
a fixture for holding said hard material, said fixture being adjacent to said path, said fixture being configured to move said hard material into said path, whereby said moving tensioned wire cuts into said hard material.

10. The wire saw of claim 9, further comprising a system configured to deliver lubricating fluid to the surface of said hard material where contact is made with said wire, wherein said lubricating fluid is water-based.

11. The wire saw of claim 10, wherein said hard material is silicon.

12. The wire saw of claim 10, further comprising:
a tray for capturing said lubricating fluid after said lubricating fluid leaves the surface of said material; and
a reservoir connected to said tray for storing said lubricating fluid captured by said shield.

13. The wire saw of claim 9, wherein said wire comprises a plurality of fibers, each fiber being spun from carbon nanotubes, said fibers being twisted together to form said wire.

14. The wire saw of claim 13, wherein said wire further comprises diamond particles incorporated on the surface of said fibers, for making said wire more abrasive.

15. The wire saw of claim 13, wherein said wire further comprises silicon carbide particles incorporated on the surface of said fibers, for making said wire more abrasive.

16. The wire saw of claim 13, wherein said wire further comprises carbon nanotubes incorporated on the surface of said fibers, for making said wire more abrasive.

17. The wire saw of claim 9, wherein said mechanism comprises:
a first reel;
a second reel, spaced apart from and axially parallel to said first reel, wherein said wire has first and second ends, the first end of said wire being wound around said first reel, the second end of said wire being wound around said second reel; and
a multiplicity of drums configured to translate said wire.

18. The wire saw of claim 9, wherein said wire is a continuous loop wire and wherein said mechanism comprises a multiplicity of drums configured to translate and tension said continuous loop wire.

19. The wire saw of claim 9, wherein said fixture is further configured to produce a relative reciprocating movement between said hard material and said wire.

20. A method of slicing a silicon boule comprising the steps of:
linearly translating a carbon nanotube fiber wire along a path while maintaining said wire under tension along said path, wherein said path is adjacent to a fixture for holding said silicon boule;
moving said silicon boule onto said moving tensioned wire, whereby said wire cuts into said silicon;
delivering lubricating fluid to the surface of said silicon where contact is made with said wire; and
collecting said lubricating fluid after said lubricating fluid leaves the surface of said silicon.

21. The method of claim 20, wherein said wire comprises a plurality of fibers, each fiber being spun from carbon nanotubes, said fibers being twisted together to form said wire.

22. The wire saw of claim 21, wherein said wire further comprises diamond particles incorporated on the surface of said fibers, for making said wire more abrasive.

23. The wire saw of claim 21, wherein said wire further comprises silicon carbide particles incorporated on the surface of said fibers, for making said wire more abrasive.

24. The wire saw of claim 21, wherein said wire further comprises carbon nanotubes incorporated on the surface of said fibers, for making said wire more abrasive.

25. The method of claim 20, wherein said lubricating fluid is water-based.
